(19) United States
(12) Patent Application Publication
(10) Pub. No.: US 2025/0323874 A1
(43) Pub. Date: Oct. 16, 2025

(54) RATE LIMITING AT THE EDGE

(71) Applicant: PayPal, Inc., San Jose, CA (US)

(72) Inventors: Sachin Kumar Singh, Lucknow (IN); Rushi Suthar, North York (CA); Gurudatha Baliga, Chandler, AZ (US)

(21) Appl. No.: 18/634,500

(22) Filed: Apr. 12, 2024

(51) Int. Cl. H04L 47/25; H04L 67/568

(52) U.S. Cl. CPC H04L 47/25; H04L 67/568

(57) ABSTRACT

Techniques are disclosed that relate to rate limiting network traffic at a content distribution network based on decisions provided by a rate limiter located on an on-premise network. A computer system may receive, at the CDN, network traffic requesting access to a service associated with an on-premise network. The computer system sends, to a second computing system deployed in the on-premise network, a request to decide whether to rate constrain the network traffic. The second computing system is configured to perform an analysis on the network traffic. In response to the request, the computer system receives a decision from the second computing system. The computer system implements the decision for the network traffic at the CDN.

### BACKGROUND

### Technical Field

This disclosure relates generally to computer systems and, more specifically, to various mechanisms for rate limiting network traffic at a content distribution network.

### Description of the Related Art

High-traffic websites and Internet-based applications may receive and process thousands of requests to access their services per day. As a result, these websites and applications often employ various techniques to manage that network traffic. For example, a load balancer may be used to distribute incoming network traffic evenly across multiple servers. In some instances, if the network traffic exceeds a maximum threshold, rate limiting may be used to restrict the number of requests to the website or application. Rate limiting can also be helpful, for example, to prevent a distributed denial-of-service (DDoS) attack in which an attacker attempts to overload a server using excessive network traffic.

### BRIEF DESCRIPTION OF THE DRAWINGS

FIG. 1 is a block diagram of one embodiment of a system that is capable of rate limiting network traffic at a content distribution network based on a decision generated by an on-premise network.

FIG. 2 is a block diagram of one embodiment of an on-premise network rate limiter that is capable of performing an analysis on network traffic to generate a decision.

FIG. 3 is a communication diagram illustrating a decision exchange between the CDN rate limiter and the OP rate limiter.

FIG. 4 is a communication diagram illustrating a cache based exchange between the CDN rate limiter and a decision cache.

FIG. 5-7 are flow diagrams illustrating embodiments of methods implementing techniques described herein.

FIG. 8 is a block diagram illustrating elements of an exemplary computer system for implementing techniques described herein.

### DETAILED DESCRIPTION

In many cases, enterprises deploy and manage their applications on a local infrastructure referred to as an on-premise (OP) network. Nodes (e.g., server systems, hosted virtual machines (VMs), etc.), database systems, and other resources can be located at the on-premise network to enable the deployment and execution of applications (e.g., web applications). Because the on-premise network may not be located near a client across the Internet, it may be necessary to store cached content, from the on-premise network, at an edge node within a content distribution network (CDN). Accordingly, when a client sends a request to access content, such as a website, from the on-premised network, the request may instead be routed and processed by the nearest edge node. If the edge node is unable to process the request (e.g., the CDN does not cache the requested webpage), the edge node forwards the request to a rate limiter located on the on-premise network. The finite resources utilized by the on-premise network may then be reallocated in order for the on-premise rate limiter to analyze and restrict these requests. Because the on-premise network has limited resources, an influx of network traffic, such as in the event of a distributed denial-of-service (DDoS) attack, can consume the available resources of the on-premise network. Services provided by the on-premise network may be disrupted as the on-premise network may no longer have available resources to process licit requests.

The present disclosure describes embodiments in which a computing system, implementing a CDN, is used to rate limit network traffic destined for the on-premise network by implementing decisions, generated by an on-premise rate limiter, at the CDN. As will be described below in various embodiments, the system may receive network traffic that requests access to a service provided by the on-premise network. For example, a client may send an HTTP request to access a web service that is routed to an edge node provided by the CDN. As part of rate limiting the network traffic, the CDN system may send a request to a second computing system deployed on the on-premise network, requesting that the OP system to decide whether to rate limit the network traffic based on performing an analysis on the network traffic. In response to sending the request, the CDN system receives a decision from the OP system that instructs the CDN system to block the network traffic, to permit the network traffic to pass to the OP network, or to issue a challenge-response test to the source of the network traffic. Based on the instructions, the CDN system implements the decision accordingly.

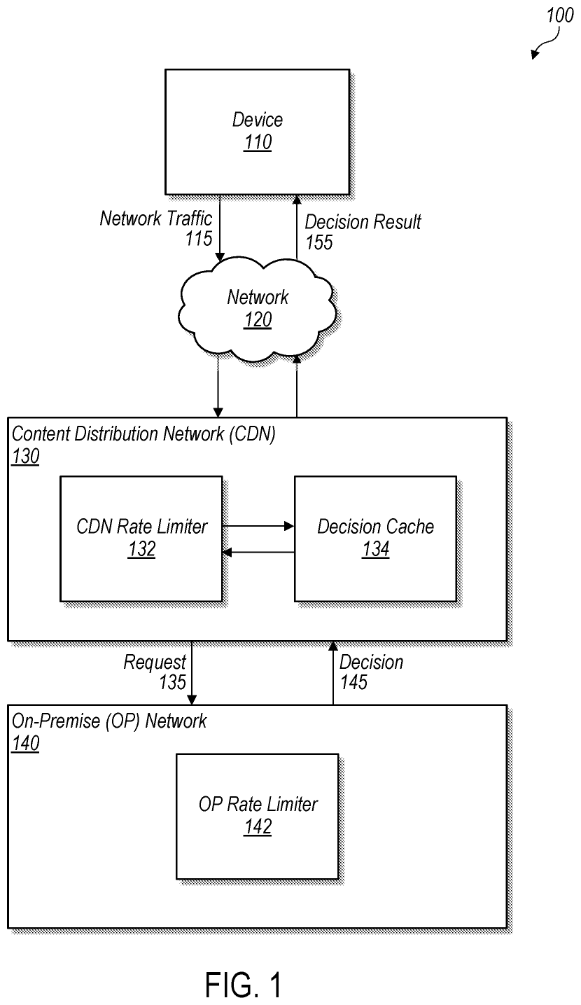

These techniques may be advantageous over prior approaches as these techniques allow for a system, implementing a CDN, to rate limit network traffic destined for the on-premise network by caching rate limit decisions at the CDN. By rate limiting network traffic at the CDN, this mitigates the impact of an attack, such as a DDoS attack, from accessing and disrupting services provided by the on-premise network. As a result, this ensure services remain available to licit network traffic. An exemplary application of these techniques will now be discussed, starting with reference to FIG. 1.

Turning now to FIG. 1, a block diagram of system 100 is shown. System 100 includes a set of components that may be implemented via hardware or a combination of hardware and software routines. In the illustrated embodiment, system 100 includes device 110, network 120, content distribution network (CDN) 130, and on-premise (OP) network 140. As further depicted, content distribution network 130 includes CDN rate limiter 132 and decision cache 134. As further depicted, OP network 140 includes an OP rate limiter 142. In some embodiments, system 100 is implemented differently than shown. For example, CDN rate limiter 132 may generate decision 145.

System 100, in various embodiments, is a system that rate limits network traffic 115, destined for the on-premise (OP) network 140, at the content distribution network (CDN) 130 by implementing a decision 145 generated by a rate limiter deployed on OP network 140. On-premise (OP) network 140, in various embodiments, is a platform that provides one or more services (e.g., a cloud computing service, a customer relationship management service, and a payment processing service) that are accessible to clients that can invoke functionality of the services to achieve a client-desired objective. In order to facilitate the functionality of those services, OP network 140 may execute various software routines, such as OP rate limiter 142, as well as provide code, web pages, and other data to users, databases, and other entities that use OP network 140. OP network 140 is implemented using infrastructure hardware and software applications that are hosted on-site as opposed to a public cloud. Components of the OP network 140, such as OP rate limiter 142, may thus execute on and utilize the available resources of that on-site infrastructure (e.g., computing resources, storage resources, etc.) to facilitate their operation. Because OP network 140 may not be located near a client, OP network 140 utilizes a content distribution network (CDN) 130 to store cached content closer to the client.

Content distribution network (CDN) 130, in various embodiments, is a network of edge nodes that are geographically distributed such that the edge node is physically located closer to a client. In various embodiments, CDN 130 is implemented using a cloud infrastructure that is provided by a cloud provider. Components of the CDN 130 may thus execute on and utilize the available cloud resources of that cloud infrastructure (e.g., computing resources, storage resources, etc.) to facilitate their operation. As an example, software that is executable to implement functionality of CDN rate limiter 132 may be stored on a non-transitory computer-readable medium of server-based hardware that is included in a datacenter of the cloud provider. That software may be executed within a virtual environment that is hosted on the server-based hardware. In some embodiments, CDN 130 is implemented using a local or private infrastructure as opposed to a public cloud. In some embodiments, CDN 130 may be accessible via a cellular network (e.g., a 5G network)—or even provided by network infrastructure (e.g., one or more edge servers, which may be co-located with a gNodeB base station). In some embodiments, one or more aspects described with respect to CDN 130 may be implemented on device 110, which may include one or both of CDN rate limiter 132 and decision cache 134 discussed below. When a client sends a request from device 110 to access content from OP network 140, the request is redirected by a Domain Name System (DNS) and processed by an edge node within CDN 130.

Device 110 may correspond to any suitable device that is configured to send a request (e.g., HTTP request) over network 120 to access a service provided by OP network 140. In some embodiments, device 110 is a mobile device such as a mobile phone, tablet computer, handheld computer, music player, laptop or notebook computer, personal data assistant (PDA), consumer device, etc. In some embodiments, device 110 is an internet of things (IoT) device, server system, desktop computer, mainframe computer system, workstation, network computer, etc. In some embodiments, device 110 is a wearable device such as a watch, athletic sensor, or a head mounted display, which may be a headset, helmet, goggles, glasses, a phone inserted into an enclosure, etc. In some embodiments, device 110 is a vehicle such as an aircraft, marine vessels, recreational vehicles (RVs), automobiles, buses, railed vehicles, spacecraft, robotic devices, trucks, trailers, cranes, caterpillars, etc.

When network traffic 115 from device 110 is received at CDN 130, it is rate constrained by CDN rate limiter 132. CDN rate limiter 132, in various embodiments, is software executable to rate limit network traffic 115 at CDN 130 by implementing decisions 145. In response to receiving new network traffic 115, CDN rate limiter 132 sends a request 135 to OP rate limiter 142, implemented by OP network 140, to determine whether to rate constrain network traffic 115. Request 135 can include information usable by OP rate limiter 142 when analyzing network traffic 115 to generate decision 145, such as the source (e.g., identity of CDN 130) of request 135, a timestamp of request 135, metadata associated with network traffic 115 (e.g., type of network traffic 115), rate at which network traffic 115 is being received at CDN 130, internet protocol (IP) address of network traffic 115, etc. For example, request 135 may include the particular HTTP request received by CDN rate limiter 132, the request rate of the same HTTP request, the current traffic volume at CDN 130, the geographic origin of the HTTP request, the HTTP request's destination URL, etc.

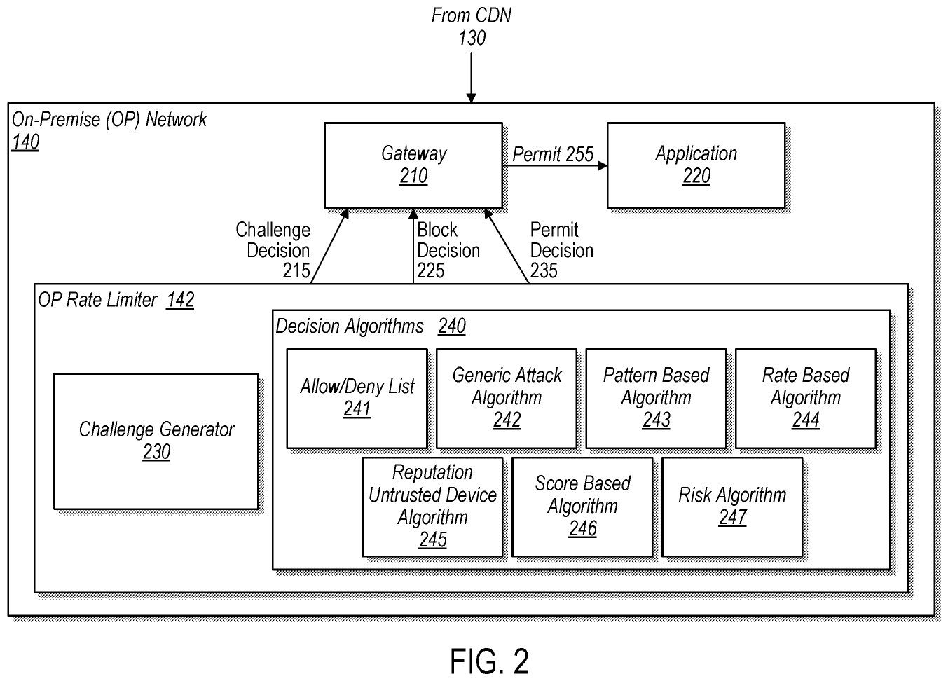

OP rate limiter 142, in various embodiments, is software executable to perform an analysis on network traffic 115 and generate a decision 145 based on that analysis. Decision 145, in various embodiments, is a decision to block network traffic 115 from accessing OP network 140, a decision to permit network traffic 115 to access OP network 140, or a decision to challenge network traffic 115 by issuing a challenge-response test. For example, OP rate limiter 142 may assess an HTTP request to access a webservice using a machine learning algorithm, and based on the results, OP rate limiter 142 may determine to block the HTTP request. OP network 140, OP rate limiter 142, and decision 145 are discussed in greater detail with respect to FIG. 2. As shown in the illustrated embodiment, OP rate limiter 142 provides decision 145 to CDN rate limiter 132.

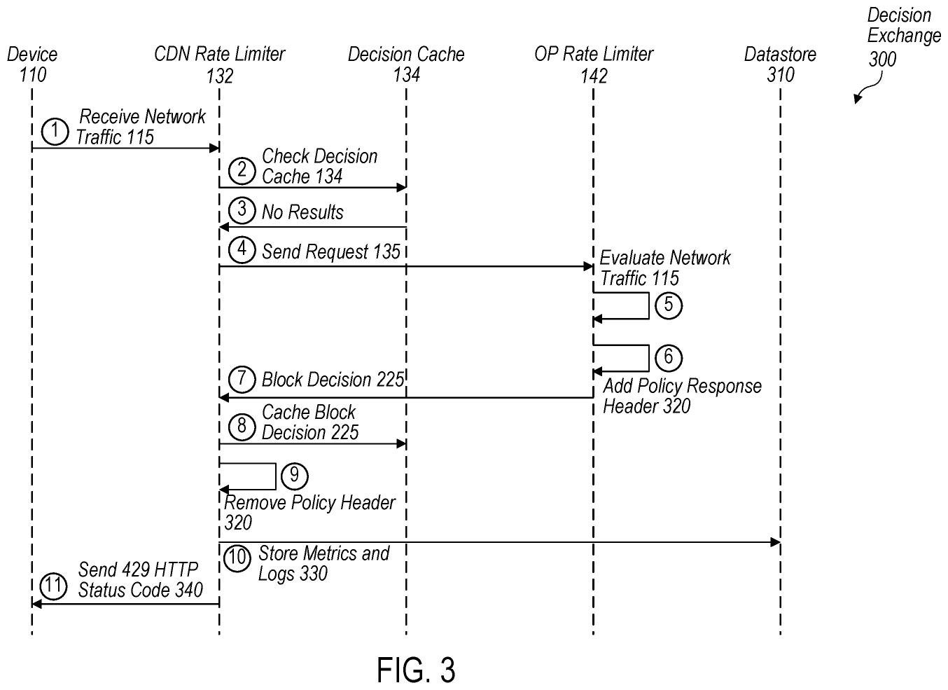

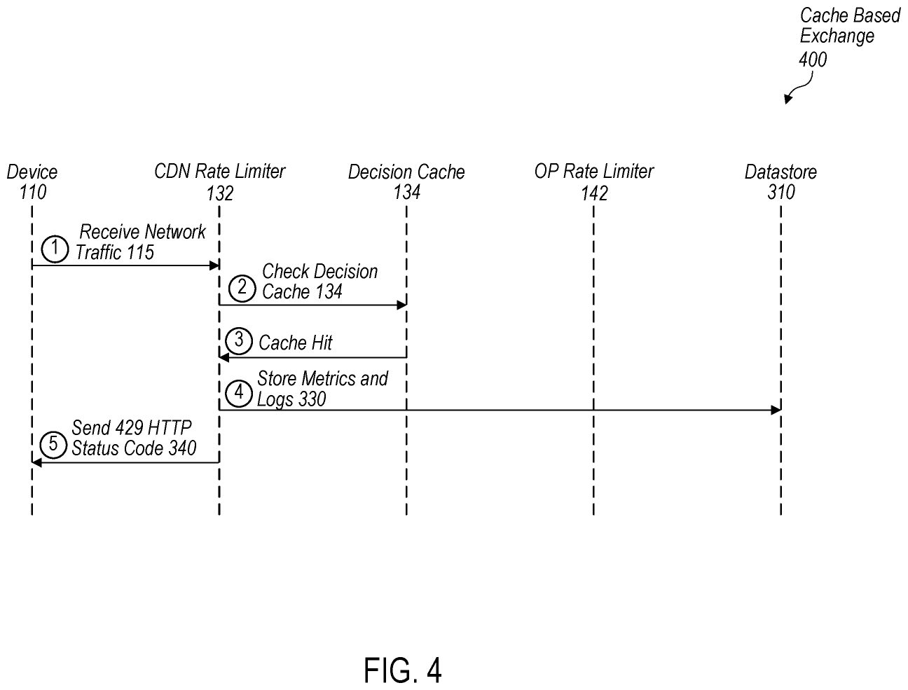

In response to receiving decision 145, CDN rate limiter 132 rate limits network traffic 115 in accordance with decision 145 and sends decision result 155 to device 110. For example, CDN rate limiter 132 may receive a decision 145 to block network traffic 115, and accordingly, CDN rate limiter 132 blocks network traffic from accessing OP network 140. CDN rate limiter 132 is discussed in greater detail with respect to FIGS. 3 and 4. CDN rate limiter 132, in various embodiments, stores decision 145 for network traffic 115 in decision cache 134. Decision cache 134, in various embodiments, is configured to store one or more decisions 145 received from OP rate limiter 142. In some embodiments, OP rate limiter 142 stores decision 145 in decision cache 134. Decision cache 134 is discussed in greater detail with respect to FIG. 4.

Turning now to FIG. 2, a block diagram of components within OP network 140 is shown. In the illustrated embodiment, on-premise (OP) network 140 includes gateway 210, application 220, and OP rate limiter 142. As shown, OP rate limiter 142 includes challenge generator 230 and decision algorithms 240. As further depicted, decision algorithms 240 includes allow/deny list 241, generic attack algorithm 242, pattern based algorithm 243, rate based algorithm 244, reputation untrusted device algorithm 245, score based algorithm 246, and risk algorithm 247. Components 210-247 may be implemented via hardware or a combination of hardware and software routines. In some embodiments, OP network 140 is implemented differently than shown. For example, decision algorithms 240 may include a fewer or greater number of decision algorithms 240.

In the illustrated embodiment, gateway 210 routes request 135 and/or network traffic 115 to OP rate limiter 142. OP rate limiter 142, in various embodiments, is software executable to perform an analysis on network traffic 115, using one or more decision algorithms 240, to determine whether to rate limit traffic 115 and generate decision 145, accordingly. Decision 145, in various embodiments, is a block decision 225 to block network traffic 115 from accessing application 220, a permit decision 235 to permit network traffic 115 to access application 220, or a challenge decision 215 to challenge network traffic 115 by issuing a challenge-response test. OP rate limiter 142 may use one or more decision algorithms to generate block decision 225, permit decision 235, and challenge decision 215.

Allow/deny list 241, in various embodiments, is a list of individual IP addresses and/or range of IP addresses that are permitted or blocked from accessing OP network 140. An IP address associated with network traffic 115 from a known malicious source may be added to the deny list. When OP rate limiter 142 receives network traffic 115 from device 110 with the same IP address, OP rate limiter 142 generates block decision 225. An IP address associated with network traffic 115 from a verified source may be added to the allow list. When rate limiter 142 receives network traffic 115 with the same IP address, rate limiter 142 generates permit decision 235. In some embodiments, allow/deny list 241 is a list of user accounts, session identifiers, device identifiers, etc. that are permitted or blocked from accessing OP network 140. For example, a user account that has been verified through an authentication process may be added to allow list 241 such that OP rate limiter 142 may generate a permit decision 235 based on that allow list 241. In some embodiments, allow/deny list 241 may be stored on CDN 130 and is accessible to CDN rate limiter 132. For example, CDN rate limiter 132 may be configured to access allow/deny list 241 and implement rate limiting for network traffic 115, accordingly.

Generic attack algorithm 242, in various embodiments, is an algorithm that identifies and/or predicts characteristics, from network traffic 115, that are exhibited as part of an attack, such as a DDoS attack, brute force attack, SYN flood attack, etc. Characteristics of an attack may include an unusual increase (e.g., spike) in network traffic 115 from one or more IP addresses, an unusual increase in a particular type of network traffic 115 (e.g., SYN requests), an unusual increase in traffic 115 from a particular geographic location, and/or an unusual increase in traffic 115 with an invalid payload (e.g., malformed packets, SQL injection, etc.). For example, OP rate limiter 142 may identify a SYN flood attack based on a spike in SYN requests to CDN 130. As a result, OP rate limiter 142 may generate block decision 225. In some embodiments, characteristics of an attack may also include an unusual increase (e.g., spike) in traffic 115 from similar behavioral profiles, such as a particular device type, operating system, web browser, geolocation, etc. In some embodiments, generic attack algorithm 242 is a machine learning model trained to identify and/or predict characteristics of an attack.

Pattern based algorithm 243, in various embodiments, is an algorithm that identifies and/or predicts patterns from network traffic 115. Network traffic 115 that exhibits abnormal patterns (e.g., an unusual log-in request) may be indicative of a malicious actor attempting to infiltrate a computer system to cause adverse or otherwise negative effects. These patterns may include user behavioral information, such as user agent data (e.g., web browser), typing patterns (e.g., typing speed), cursor movements, and sensor (e.g., accelerometer) readings. For example, pattern based algorithm 243 may identify typing patterns, such as typing speed, associated with a particular user. Accordingly, if the user is exhibiting unusual typing patterns, OP rate limiter 142 may generate block decision 225. In some embodiments, pattern based algorithm 243 is a machine learning model that has been trained from historical usage data to identify these traffic patterns. For example, a neural network may be trained to classify or predict incoming HTTP requests as being performed by bots based on abnormal traffic patterns.

Rate based algorithm 244, in various embodiments, is an algorithm that determines the frequency of requests received at CDN 130 and, if the frequency satisfies a threshold, causes OP rate limiter 142 to generate block decision 225. In some embodiments, algorithm 244 may use a rate limiting technique such as token bucket, leaky bucket, fixed window, sliding window, etc. For example, OP rate limiter 142 may be configured to allow a maximum of hundred requests per minute from device 110. If algorithm 244 determines that device 110 has exceeded that limit, OP rate limiter 142 may determine to issue block decision 225. In some embodiments, CDN rate limiter 132 provides metadata, such as the request frequency, to OP rate limiter 142. Rate based algorithm 244 may then determine to issue a decision 145 based on that metadata. For example, CDN rate limiter 132 may maintain a counter that counts the number of requests received during a time period and may provide that information with request 135. As a result, OP rate limiter 142 may determine to block network traffic 115 based on that information.

Reputation untrusted device algorithm 245, in various embodiments, is an algorithm to determine whether device 110 is a “trusted” device. A trusted device may be a device 110 that is registered to a verified user account and/or has been previously used by a user account to access application 220. For example, a request associated with a user account may be sent via a different device rather than a device frequently used by the same user account. As a result, OP rate limiter 142 may generate block decision 225. In some embodiments, a trusted device may be a device 110 that is verified via one or more tokens. For example, algorithm 245 may determine to issue permit decision 235 based on validating a cookie stored on device 110.

Scored based algorithm 246, in various embodiments, is an algorithm that calculates a score (e.g., probability) for classifying network traffic 115 (e.g., normal or malicious traffic) based on the characteristics exhibited by traffic 115 and/or metadata provided with request 135 such that OP rate limiter 142 generates a decision 145 based on that classification. For example, algorithm 246 may calculate a score that indicates the level of abnormality for a log-in process relative to known licit log-in interactions. This score may be a summation of several weighted factors that are assessed for a given login such as a user's location, whether the user is logging in from a previously used device, the number of failed login attempts, whether the user is logging via a web browser or a dedicated application, etc. If the calculated score satisfies a threshold, algorithm 246 may classify the log-in process as an anomaly. In some embodiments, score based algorithm 246 is a machine learning model trained to classify network traffic 115 based on its respective features. For example, algorithm 246 may embed a vector representation for traffic 115 in an embedding space and generate a score based on the distance between the vector representation and one or more vector representations of licit network traffic. In some embodiments, OP rate limiter 142 may determine to generate a challenge, using challenge generator 230, based on the determined score.

Risk algorithm 247, in various embodiments, is an algorithm that calculates a score representing the amount of risk associated with network traffic 115 based on the characteristics exhibited by traffic 115 and/or metadata provided with request 135. Accordingly, OP rate limiter 142 generates decision 145 based on that score satisfying a particular threshold. For example, the risk score for network traffic 115 may range from 0 to 100 such that a score closer to 100 indicates a higher level of risk. As a result, OP rate limiter 142 may determine to generate block decision 225 if the score is above 60. In some embodiments, risk algorithm 247 is a machine learning model trained, using historical data, to score network traffic 115. For example, algorithm 247 may embed a vector representation for traffic 115 in an embedding space and generate a risk score based on the distance between the vector representation and one or more vector representations of licit network traffic 115. In some embodiments, OP rate limiter 142 may determine to generate a challenge, using challenge generator 230, if the risk score satisfies a threshold.

Challenge generator 230, in various embodiments, is software executable to generate a challenge that asks for a response indicative of whether a human is present at the source of network traffic 115. A challenge may include a text-based, picture-based, and/or audio-based test that requires a response from a user. In some embodiments, a challenge may be a “completely automated Turing test to tell computers and humans apart” (CAPTCHA). For example, CAPTCHAs may require a user to identify distorted letters, type the correct sequence of those letters into a form field, and then submit the form. In some embodiments, challenge generator 230 may generate a challenge and provide it with challenge decision 215. For example, score based algorithm 246 may classify network traffic 115 as “undefined”, and as a result, challenge generator 230 may send a challenge to CDN rate limiter 132 for implementation.

Turning now to FIG. 3, a diagram illustrating decision exchange 300 is shown. In some embodiments, decision exchange 300 is implemented differently than shown. At 1, CDN rate limiter 132 receives network traffic 115 from device 110. For example, CDN rate limiter 132 may receive an HTTPS request to access a web service implemented by OP network 140. At 2, in response to receiving network traffic 115, CDN rate limiter 132 accesses decision cache 134 to identify a particular decision 145 associated with network traffic 115. For example, CDN rate limiter 132 may identify a particular cached decision 145 in decision cache 134 for network traffic 115 based on a corresponding IP address and implements the cached decision 145 for traffic 115, accordingly. The process for a cache-based exchange based on a cache hit is discussed with respect to FIG. 4.

At 3, CDN rate limiter 132 is unable to identify a cached decision 145 for network traffic 115 in decision cache 134. At 4, in response to a cache miss, CDN rate limiter 132 generates and sends request 135 to OP rate limiter 142. For example, CDN rate limiter 132 may generate a request 135 that includes user-agent data from a log-in attempt, and CDN rate limiter 132 forwards network traffic 115 with that request 135 to OP rate limiter 142. In some embodiments, CDN rate limiter 132 generates and sends request 135 to OP rate limiter 142 without checking decision cache 134.

At 5, OP rate limiter 142 evaluates network traffic 115, using decision algorithms 240, to determine whether to rate limit network traffic 115 at CDN 130. For example, OP rate limiter 142 may calculate a risk score, using risk algorithm 247, that classifies network traffic 115 as high risk, and as a result, OP rate limiter 142 generates block decision 225. At 6, OP rate limiter 142 adds the decision 145 as a policy response header 320 to its HTTP response (e.g., a 429 HTTP response) to request 135 based on its evaluation of network traffic 115. In some embodiments, policy response header 320 includes metadata associated with its decision 145. For example, policy response header 320 may include the decision algorithm 240 used to generate decision 145. In some embodiments, policy response header 320 includes instructions and/or metadata for caching decision 145 in decision cache 134. Policy response header 320 may include HTTP cache headers, such as cache-control header, expires header, entity tag header, etc. For example, policy response header 320 may define an expiration time for decision 145, and after the expiration time is satisfied, decision 145 may be removed from decision cache 134.

At 7, OP rate limiter 142 sends block decision 225 to CDN rate limiter 132 for implementation at CDN 130. For example, OP rate limiter 142 may instruct CDN rate limiter 132 to block network traffic 115 for a period of time. In some embodiments, OP rate limiter 142 may send permit decision 235 or challenge decision 215 to CDN rate limiter 132. At 8. CDN rate limiter 132 caches block decision 225 in decision cache 134, according to policy response header 320. In some embodiments, CDN rate limiter 132 caches block decision 225, permit decision 235, and/or challenge decision 215 in decision cache 134.

At 9, CDN rate limiter 132 removes policy response header 320 from decision 145. At 10, CDN rate limiter 132 stores metrics and logs 330 associated with decision exchange 300 in datastore 310. Metrics and logs 330, in various embodiments, are metrics pertaining to the implementation of decision 145. For example, CDN rate limiter 132 may track the number of times a particular decision 145 is implemented at CDN 130, and accordingly, this information may be used to further analyze additional network traffic 115 and/or update decision algorithms 240, such as allow/deny list 241. At 11, CDN rate limiter 132 sends a 429 HTTP status code 340 to device 110 based on block decision 225. A 429 HTTP status code 340, in various embodiments, is an error code that indicates that device 110 has sent too many requests within a given amount of time. For example, 429 HTTP status code 340 may be displayed in a web browser of device 110 and include a retry-after header. In some embodiments, status code 340 is a HTTP response status code, such as a 503 status code, a 504 status code, a 502 status code, a 500 status code, etc. For example, CDN rate limiter 132 may send a 503 HTTP status code to the client which indicates that services are unavailable.

In some embodiments, CDN rate limiter 132 permits network traffic 115 to access OP network 140 in response to receiving permit decision 235. For example, OP rate limiter 142 may determine to permit network traffic 115 from a trusted device based on algorithm 245, and as a result, OP rate limiter 142 generates and sends permit decision 235 to CDN rate limiter 132. In some embodiments, CDN rate limiter 132 sends a challenge to device 110 based on challenge decision 215. For example, CDN rate limiter 132 may receive a visual test from challenge generator 230 with challenge decision 215, and rate limiter 132 may send the visual test to device 110. Accordingly, CDN rate limiter 132 may forward the response to the challenge test to OP rate limiter 142 for a final decision 145.

Turning now to FIG. 4, a communication diagram illustrating cache based exchange 400 is shown. In some embodiments, cache based exchange 400 is implemented differently than shown. For example, CDN rate limiter 132 may permit network traffic 115 in response to a cached decision stored in decision cache 134.

At 1, CDN rate limiter 132 receives network traffic 115 from device 110. For example, CDN rate limiter 132 may receive a SYN packet from a desktop computer to initiate a TCP connection with OP network 140. At 2, in response to receiving network traffic 115, CDN rate limiter 132 checks decision cache 134 for a cached decision 145 that informs CDN rate limiter 132 whether to rate limit network traffic 115. A cached decision 145, in various embodiments, is a block decision 225, a permit decision 235, and/or a challenge decision 215 previously generated by OP rate limiter 142 based on decision algorithms 240. A cached decision 145 may be identified for a particular network traffic 115 based on an IP address, device identifier, user account, policy response header 320, etc. For example, CDN rate limiter 132 may check for a cached decision 145 associated with the same IP address as network traffic 115. At 3, CDN rate limiter 132 receives a cache hit from decision cache 134 to implement at CDN 130.

At 4, CDN rate limiter 132 stores metrics and logs 330 at datastore 310. For example, CDN rate limiter 132 may record the number of times a particular cached decision 145 has been implemented. At 5, CDN rate limiter 132 sends a 429 HTTP status code 340 to device 110 based on cache block decision 225. For example, 429 a HTTP status code 340 may be displayed in a web browser of device 110 and advise the user to reattempt to connect application 220 after a period of time. In some embodiments, the cache hit is a cached permit decision 234, and in response to permit decision 234, CDN rate limiter 132 forwards network traffic 115 OP network 140 to access a service, such as application 220. In some embodiments, CDN rate limiter 132 may permit network traffic 115 to access cached content stored at CDN 130.

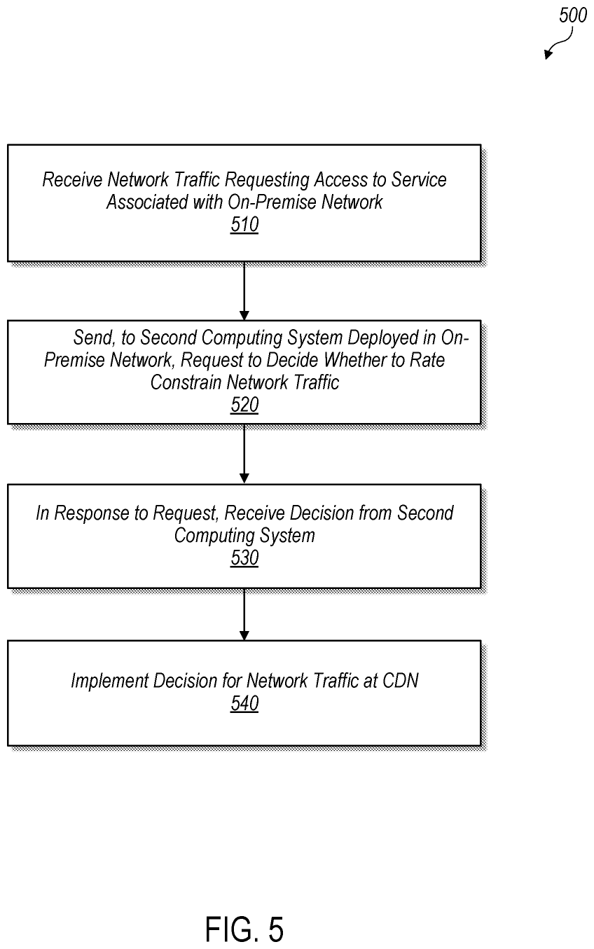

Turning now to FIG. 5, a flow diagram of a method 500 is depicted. Method 500 is one embodiment of a method that may be performed by a computer system implementing a content distribution network (e.g., CDN 130). Method 500 may be performed by executing a set of program instructions stored on a non-transitory computer-readable medium. In many instances, performance of method 500 may prevent an attack destined for an on-premise network by rate limiting network traffic at the CDN.

At 510, the computer system (e.g., CDN rate limiter 132), implementing a content distribution network (CDN), receives, at the CDN, network traffic (e.g., network traffic 115) requesting access to a service (e.g., application 220) associated with an on-premise network (e.g., OP network 140).

At 520, the computer system sends, to a second computing system (e.g., OP rate limiter 142) deployed in the on-premise network, a request (e.g., request 135) to decide whether to rate constrain the network traffic. The second computing system is configured to perform an analysis (e.g., decision algorithms 240) on the network traffic. The request, in various embodiments, is a request for the second computer system to determine whether the network traffic is associated with a denial of service attack.

At 530, the computer system receives a decision (e.g., decision 145) from the second computing system in response to the request. The decision, in various embodiments, includes one of blocking the network traffic (e.g., blocking decision 225), permitting the network traffic (e.g., permit decision 235) to pass to the on-premise network, and issuing a challenge (e.g., challenge decision 215) to a source (e.g., device 110) of the network traffic. In various embodiments, the computer system issues the challenge (e.g., challenge generator 230) by sending a challenge that asks for a response indicative of whether a human is present at the source. Based on the response, the computer system permits (e.g., permits 255) the source to access the service. In various embodiments, the decision specifies one or more internet protocol (IP) addresses applicable to the decision. The decision may specify a time duration for which the decision is applicable, and the computer system applies the decision to the network traffic for the specified time duration.

At 540, the computer system implements the decision for the network traffic at the CDN. In various embodiments, the computer system stores, at the CDN, the received decision in a cache (e.g., decision cache 134) including a plurality of decisions. In response to receiving additional network traffic, the computer system may identify a particular one of the cached decisions associated with the additional network traffic. The computer system may implement the particular decision for the additional network traffic. In various embodiments, the computer system deploys a container including a rate limiter application that sends the request to the second computing system deployed in the on-premise network and implements the decision for the network traffic at the CDN. The computer system receives, at the container, the network traffic requesting access to the service, and the computer system rate constrains, by the container, the network traffic to implement the decision. In various embodiments, the computer system provides, by the container, one or more instructions to network hardware to rate constrain the network traffic in accordance with the decision.

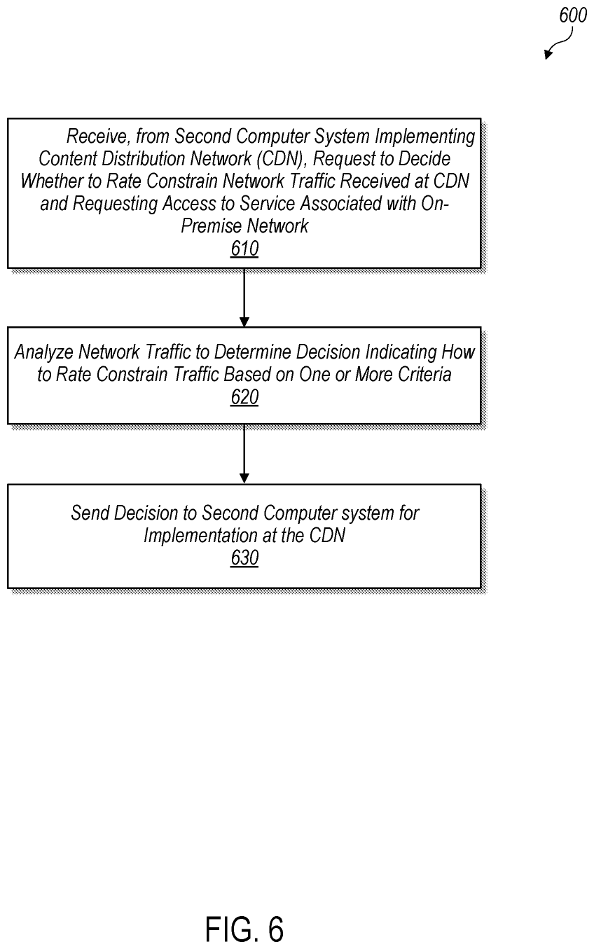

Turning now to FIG. 6, a flow diagram of a method 600 is shown. Method 600 is one embodiment of a method that may be performed by a computer system implementing an on-premise network (e.g., OP network 140). Method 600 may be performed by executing a set of program instructions stored on a non-transitory computer-readable medium. In many instances, performance of method 600 may prevent an attack destined for an on-premise network by rate limiting network traffic at the CDN.

At 610, the computer system receives, from a second computer system (e.g., CDN rate limiter 132) implementing a content distribution network (CDN) (e.g., CDN 130), a request (e.g., request 135) to decide whether to rate constrain network traffic (e.g., network traffic 115) received at the CDN and requesting access to a service (e.g., application 220) associated with the on-premise network.

At 620, the computer system analyzes (e.g., decision algorithms 240) the network traffic to determine a decision (e.g., decision 145) indicating how to rate constrain the traffic based on one or more criteria. In various embodiments, the computer system applies a machine learning algorithm to identify one or more patterns (e.g., pattern based algorithm 243) in the network traffic and determines the decision based on the network traffic having the one or more patterns. In various embodiments, the computer system determines a frequency (e.g., rate based algorithm 244) at which the network traffic is received from a source (e.g., device 110) and determines the decision based on the rate satisfying a threshold. In various embodiments, the computer system applies a risk assessment algorithm (e.g., risk algorithm 247) to determine a risk score and determines the decision based on the risk score satisfying a threshold. In various embodiments, the computer system maintains a list (e.g., allow/deny list 241) indicative of whether particular network traffic is permitted to be received by the on-premise network and determines the decision based on the list. In various embodiments, the computer system determines whether the network traffic is associated with a denial-of-service attack.

At 630, the computer system sends the decision to the second computer system for implementation at the CDN. In various embodiments, the computer system instructs the second computing system to perform one of blocking network traffic (e.g., block decision 225) at the CDN, permitting (e.g., permit decision 235) the network traffic to pass to the on-premise network, and issuing a challenge (e.g., challenge decision 215) to a source of the network traffic. In various embodiments, the computer system tracks metrics (e.g., metrics and logs 330) pertaining to the implementation of the received decision and sends the metrics to a datastore (e.g., datastore 310) of the on-premise network.

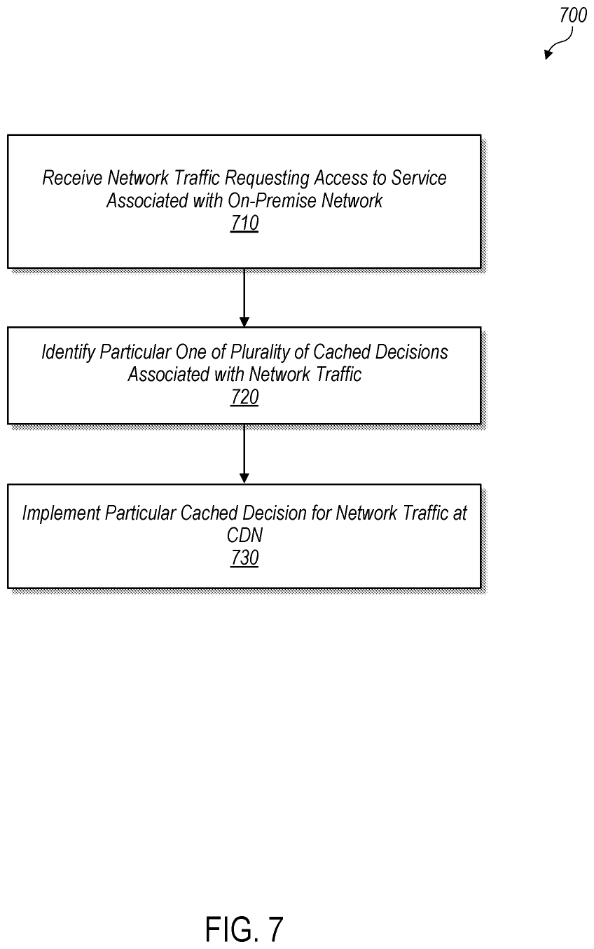

Turning now to FIG. 7, a flow diagram of a method 700 is depicted. Method 700 is one embodiment of a method that may be performed by a computer system implementing a content distribution network (e.g., CDN 130). Method 700 may be performed by executing a set of program instructions stored on a non-transitory computer-readable medium. In many instances, performance of method 700 may prevent an attack destined for an on-premise network by rate limiting network traffic at the CDN.

At 710, the computer system receives, by a first computing system implementing a content distribution network (CDN) (e.g., CDN 130), network traffic (e.g., network traffic 115) requesting access to a service (e.g., application 220) associated with an on-premise network (e.g., OP network 140).

At 720, the computer system identifies, by the first computing system, a particular one of a plurality of cached decisions associated with the network traffic. The particular cached decision may include one of blocking the network traffic (e.g., block decision 225), permitting the network traffic (e.g., permit decision 235) to pass to the on-premise network, and issuing a challenge (e.g., challenge decision 215) to a source (e.g., device 110) of the network traffic.

At 730, the computer system implements (e.g., decision result 155) the particular cached decision for the network traffic at the CDN. In various embodiments, the computer system instantiates, at the first computing system implementing the CDN, a container including a rate limiter application (e.g., CDN rate limiter 132) that implements the decision for the network traffic at the CDN. In various embodiments, the computer system receives, at the container, network traffic requesting access to the service of the on-premise network. In various embodiments, the computer system rate constraints, by the container, the network traffic to implement the decision.

### Exemplary Computer System

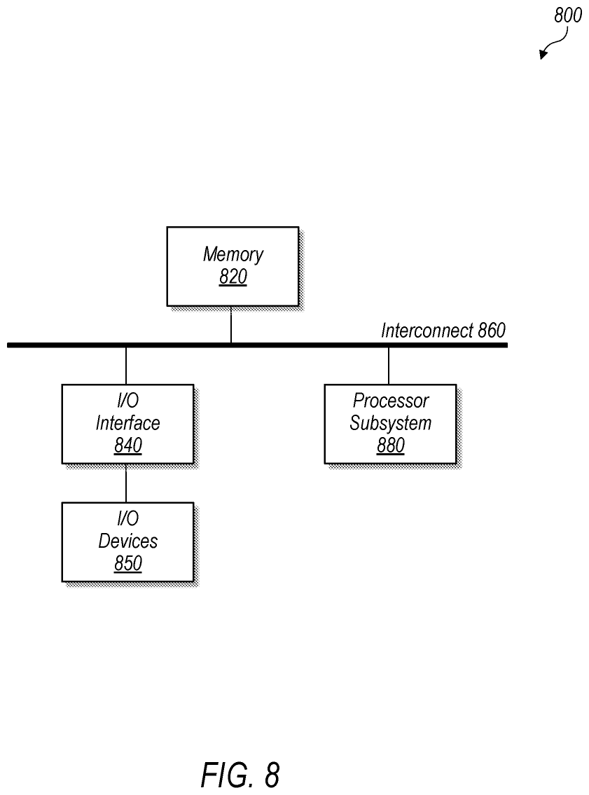

Turning now to FIG. 8, a block diagram of an exemplary computer system 800, which may implement system 100 (or one or more components included in system 100), is depicted. Computer system 800 includes a processor subsystem 880 that is coupled to a system memory 820 and I/O interfaces(s) 840 via an interconnect 860 (e.g., a system bus). I/O interface(s) 840 is coupled to one or more I/O devices 850. Although a single computer system 800 is shown in FIG. 8 for convenience, system 800 may also be implemented as two or more computer systems operating together.

Processor subsystem 880 may include one or more processors or processing units. In various embodiments of computer system 800, multiple instances of processor subsystem 880 may be coupled to interconnect 860. In various embodiments, processor subsystem 880 (or each processor unit within 880) may contain a cache or other form of on-board memory.

System memory 820 is usable store program instructions executable by processor subsystem 880 to cause system 800 perform various operations described herein. System memory 820 may be implemented using different physical memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 800 is not limited to primary storage such as memory 820. Rather, computer system 800 may also include other forms of storage such as cache memory in processor subsystem 880 and secondary storage on I/O Devices 850 (e.g., a hard drive, storage array, etc.). In some embodiments, these other forms of storage may also store program instructions executable by processor subsystem 880. In some embodiments, program instructions that when executed implement elements 132, 134, and 142 may be included/stored within system memory 820.

I/O interfaces 840 may be any of various types of interfaces configured to couple to and communicate with other devices, according to various embodiments. In one embodiment, I/O interface 840 is a bridge chip (e.g., Southbridge) from a front-side to one or more back-side buses. I/O interfaces 840 may be coupled to one or more I/O devices 850 via one or more corresponding buses or other interfaces. Examples of I/O devices 850 include storage devices (hard drive, optical drive, removable flash drive, storage array, SAN, or their associated controller), network interface devices (e.g., to a local or wide-area network), or other devices (e.g., graphics, user interface devices, etc.). In one embodiment, computer system 800 is coupled to a network via a network interface device 850 (e.g., configured to communicate over Wi-Fi®, Bluetooth®, Ethernet, etc.).

The present disclosure includes references to “embodiments,” which are non-limiting implementations of the disclosed concepts. References to “an embodiment,” “one embodiment,” “a particular embodiment,” “some embodiments,” “various embodiments,” and the like do not necessarily refer to the same embodiment. A large number of possible embodiments are contemplated, including specific embodiments described in detail, as well as modifications or alternatives that fall within the spirit or scope of the disclosure. Not all embodiments will necessarily manifest any or all of the potential advantages described herein.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third” when applied to a feature do not imply any type of ordering (e.g., spatial, temporal, logical, etc.), unless stated otherwise.

The phrase “based on” or is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, circuit, a system having a processor unit and a memory storing program instructions executable to implement the task, etc. This phrase is not used herein to refer to something intangible.

In some cases, various units/circuits/components may be described herein as performing a set of task or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112 (f) for that claim element. Should Applicant wish to invoke Section 112(f) during prosecution of a United States patent application based on this disclosure, it will recite claim elements using the “means for” [performing a function] construct.

What is claimed is:

1. A non-transitory computer readable medium having program instructions stored therein that are executable by a first computing system implementing a content distribution network (CDN) to perform operations comprising:
receiving, at the CDN, network traffic requesting access to a service associated with an on-premise network;
sending, to a second computing system deployed in the on-premise network, a request to decide whether to rate constrain the network traffic, wherein the second computing system is configured to perform an analysis on the network traffic;
in response to the request, receiving a decision from the second computing system; and
implementing the decision for the network traffic at the CDN.

2. The computer readable medium of claim 1, wherein the request is a request for the second computer system to determine whether the network traffic is associated with a denial of service attack.

3. The computer readable medium of claim 1, wherein the decision includes one of blocking the network traffic, permitting the network traffic to pass to the on-premise network, and issuing a challenge to a source of the network traffic.

4. The computer readable medium of claim 3, wherein issuing the challenge includes:
sending a challenge that asks for a response indicative of whether a human is present at the source; and
based on the response, permitting the source to access the service.

5. The computer readable medium of claim 1, wherein the decision specifies one or more internet protocol (IP) addresses applicable to the decision.

6. The computer readable medium of claim 1, wherein the decision specifies a time duration for which the decision is applicable; and
wherein the implementing includes applying the decision to the network traffic for the specified time duration.

7. The computer readable medium of claim 1, further comprising:
storing, at the CDN, the received decision in a cache including a plurality of decisions;
in response to receiving additional network traffic, identifying a particular one of the decisions associated with the additional network traffic; and
implementing the particular cached decision for the additional network traffic.

8. The computer readable medium of claim 1, wherein the operations further comprise:
deploying, at the first computing system implementing the CDN, a container including a rate limiter application that sends the request to the second computing system deployed in the on-premise network and implements the decision for the network traffic at the CDN.

9. The computer readable medium of claim 8, wherein the operations further comprise:
receiving, at the container, the network traffic requesting access to the service; and
rate constraining, by the container, the network traffic to implement the decision.

10. The computer readable medium of claim 8, wherein the implementing includes:
providing, by the container, one or more instructions to network hardware to rate constrain the network traffic in accordance with the decision.

11. A non-transitory computer readable medium having program instructions stored therein that are executable by a first computing system implementing an on-premise network to perform operations comprising:
receiving, from a second computer system implementing a content distribution network (CDN), a request to decide whether to rate constrain network traffic received at the CDN and requesting access to a service associated with the on-premise network;
analyzing the network traffic to determine a decision indicating how to rate constrain the network traffic based on one or more criteria; and
sending the decision to the second computer system for implementation at the CDN.

12. The computer readable medium of claim 11, wherein the sending includes:
instructing the second computing system to perform one of blocking network traffic at the CDN, permitting the network traffic to pass to the on-premise network, and issuing a challenge to a source of the network traffic.

13. The computer readable medium of claim 11, wherein the analyzing further includes:
applying a machine learning algorithm to identify one or more patterns in the network traffic; and
determining the decision based on the network traffic having the one or more patterns.

14. The computer readable medium of claim 11, wherein the analyzing further includes:
determining a frequency at which the network traffic is received from a source; and
determining the decision based on the frequency satisfying a threshold.

15. The computer readable medium of claim 11, wherein the analyzing further includes:
applying a risk assessment algorithm to determine a risk score; and
determining the decision based on the risk score satisfying a threshold.

16. The computer readable medium of claim 11, wherein the analyzing further includes:
maintaining a list indicative of whether particular network traffic is permitted to be received by the on-premise network; and
determining the decision based on the list.

17. The computer readable medium of claim 11 wherein the analyzing further includes:
determining whether the network traffic is associated with a denial of service attack.

18. The computer readable medium of claim 11 further comprising:
tracking metrics pertaining to implementation of the received decision; and
sending the metrics to a datastore of the on-premise network.

19. A method, comprising:
receiving, by a first computing system implementing a content distribution network (CDN), network traffic requesting access to a service associated with an on-premise network;
identifying, by the first computing system, a particular one of a plurality of cached decisions associated with the network traffic, wherein the particular cached decision includes one of blocking the network traffic, permitting the network traffic to pass to the on-premise network, and issuing a challenge to a source of the network traffic; and
implementing the particular cached decision for the network traffic at the CDN.

20. The method of claim 19, further comprising:
instantiating, at the first computing system implementing the CDN, a container including a rate limiter application that implements the decision for the network traffic at the CDN;
receiving, at the container, network traffic requesting access to the service of the on-premise network; and
rate constraining, by the container, the network traffic to implement the decision.
